(19) United States
(12) Patent Application Publication
(10) Pub. No.: US 2023/0142291 A1
(43) Pub. Date: May 11, 2023

(54) SAFETY PROTECTION SYSTEM AND METHOD FOR ENGINEERING MACHINERY

(71) Applicant: SANY HEAVY MACHINERY LIMITED, Jiangsu (CN)

(72) Inventors: Zhifei YANG, Jiangsu (CN); Xiaobo LI, Jiangsu (CN); Jiang GUO, Jiangsu (CN)

(21) Appl. No.: 17/920,400

(22) PCT Filed: Jul. 19, 2021
(86) PCT No.: PCT/CN2021/107071

§ 371 Date: Oct. 21, 2022

(30) Foreign Application Priority Data
Jul. 20, 2020 (CN) 202010701776.1

(51) Int. Cl. E02F 9/22; E02F 9/26

(52) U.S. Cl. CPC E02F 9/226; E02F 9/2285; E02F 9/26

(57) ABSTRACT

A safety protection system (100) for engineering machinery, relating to the technical field of engineering machinery. Said system comprises: multiple groups of sensors (101), a controller (102), a control valve (103), a hydraulic safety valve (104), and an operating mechanism (105); the control valve (103), the hydraulic safety valve (104), and the operating mechanism (105) are sequentially connected by means of fluid paths; the controller (102) is electrically connected to a pilot electromagnetic valve (106) in the hydraulic safety valve (104), to detect whether the pilot electromagnetic valve (106) is power on; the multiple groups of sensors (101) are respectively provided at different positions in an operating chamber of engineering machinery; the controller (102) is electrically connected to the multiple groups of sensors (101), to acquire multiple groups of operating data from the multiple groups of sensors (101) when detecting that the pilot electromagnetic valve (106) is power on; and the controller (102) is further electrically connected to the control valve (103) to determine, according to the multiple groups of operating data, whether a safe operation condition is met, and if not, to shut off the control valve (103), so as to prevent hydraulic fluid from being supplied to the operating mechanism (105). The safety protection system (100) for engineering machinery can detect the operating state of a driver, achieving safety protection for engineering machinery in a working state, and improving the safety of engineering machinery. The present invention also relates to a safety protection method for engineering machinery.

### CROSS-REFERENCE TO RELATED APPLICATIONS

The present application claims priority to Chinese Application No. 202010701776.1 filed on Jul. 20, 2020, entitled “Safety Protection System and Method for Engineering Machinery”, which is hereby incorporated by reference in its entirety.

### TECHNICAL FIELD

The present application relates to the technical field of engineering machinery, in particular to a safety protection system and a safety protection method for engineering machinery.

### BACKGROUND

With social development and construction needs, the use of engineering machinery is getting more and more widely. For example, excavators, bulldozers and loaders play an important role in mineral development, water conservancy construction and road construction. During a construction process, it is easy to cause accidents when a driver's operation is not standardized or an operating mechanism is mistakenly touched when a solenoid valve inside a hydraulic safety valve is power on.

At present, when engineering machinery is in a non-working state, an internal solenoid valve of the hydraulic safety valve is not power on, which can prevent the driver from mistakenly touching an operating handle when getting on and off a vehicle and avoid causing safety accidents. However, under normal working conditions, the internal solenoid valve of the hydraulic safety valve is in a power-on state. When an operator's operating posture is incorrect, or the operating mechanism is mistakenly touched when the operator getting off, it is easy to cause an accident.

However, using existing hydraulic safety valve has an operating state of the operator cannot be detected in real time, which will reduce the safety of engineering machinery.

### SUMMARY

An objective of the present application is to provide a safety protection system and a safety protection method for engineering machinery in view of shortcomings of the existing technology mentioned above, to detect and determine the operating state of an operator in real time and improve the safety of engineering machinery.

In order to achieve the objective mentioned above, solutions used in the present application are as follows.

An embodiment of the present application provides a safety protection system for engineering machinery, including: a plurality sets of sensors, a controller, a control valve, a hydraulic safety valve and an operating mechanism; where the control valve, the hydraulic safety valve and the operating mechanism are connected by an oil passage in sequence;

the controller is electrically connected with a pilot electromagnetic valve in the hydraulic safety valve to detect whether the pilot electromagnetic valve is power on;

the plurality sets of sensors are respectively arranged at different positions in an operating chamber of the engineering machinery; the controller is electrically connected with the plurality sets of sensors to detect a plurality sets of operating data obtained from the plurality sets of sensors when the pilot electromagnetic valve is power on;

the controller is further electrically connected with the control valve to determine whether a safe operating condition is satisfied according to the plurality sets of operating data, and to shut off the control valve to prevent hydraulic oil from supplying oil to the operating mechanism if the safe operating condition is not satisfied.

In an embodiment, the plurality sets of sensors include: a set of gravity sensors, a set of distance sensors, and a set of pressure sensors, where the set of gravity sensors is arranged below an operating seat to detect whether an operator is in a driving position;

the set of distance sensors is arranged at an inner side of a backrest of the operating seat to detect a distance between a back of the operator and the backrest;

the set of pressure sensors is arranged at an operating part of the operating mechanism to detect whether the operator performs an operating action.

In an embodiment, the safety protection system further includes: a display, where the controller is further electrically connected to the display such that the display displays corresponding indicating information on the display when it is determined that the safe operating condition is not satisfied.

In an embodiment, the safety protection system further includes: an alarm, where the controller is further electrically connected to the alarm such that the alarm sends corresponding alarm information through the alarm when it is determined that the safe operating condition is not satisfied.

An embodiment of the present application further provides a safety protection method for engineering machinery, where the safety protection method is applied to the controller in any of the safety protection systems provided by the above embodiments, the safety protection method includes:

detecting whether the pilot electromagnetic valve is power on;

obtaining a plurality sets of operating data collected by the plurality sets of sensors if the pilot electromagnetic valve is power on;

determining whether a preset safe operating condition is satisfied according to the plurality sets of operating data; and

shutting off the control valve to prevent the hydraulic oil from supplying oil to the operating mechanism if the safe operating condition is not satisfied.

In an embodiment, the plurality sets of sensors include: a set of gravity sensors arranged below an operating seat, a set of distance sensors arranged at an inner side of a backrest of the operating seat, and a set of pressure sensors arranged at an operating part of the operating mechanism.

the determining whether preset safe operating condition is satisfied according to the plurality sets of operating data includes:

determining whether the operator obeys a preset driving specification according to gravity data collected by the set of gravity sensors and distance data collected by the set of distance sensors;

determining whether the operator performs an operating action according to pressure data collected by the set of pressure sensors;

determining that the safe operating condition is not satisfied if the operator does not obey the driving specification and/or the operator does not perform the operating action; and

determining that the safe operating condition is satisfied if the operator obeys the driving specification and the operator performs the operating action.

In an embodiment, the determining whether the operator obeys a preset driving specification according to gravity data collected by the set of gravity sensors and distance data collected by the set of distance sensors includes:

determining whether the gravity data are greater than or equal to a preset gravity threshold;

determining whether the distance data is within a preset safe distance range;

determining that the operator obeys the driving specification if the gravity data is greater than or equal to the preset gravity threshold and the distance data is within the preset safe distance range; and determining that the operator does not obey the driving specification if the gravity data is less than the preset gravity threshold and/or the distance data is not within the present safe distance range.

In an embodiment, the determining whether the operator performs an operating action according to pressure data collected by the set of pressure sensors includes:

determining whether the pressure data are greater than or equal to a preset pressure threshold;

determining that the operator performs the operating action if the pressure data is greater than or equal to the preset the pressure threshold; and

determining that the operator does not perform the operating action if the pressure data are less than the preset pressure threshold.

In an embodiment, the determining whether the operator performs an operating action according to pressure data collected by the set of pressure sensors includes:

determining whether the set of pressure sensors has collected the pressure data;

determining that the operator performs the operating action if the pressure data is collected; and

determining that the operator does not perform the operating action if pressure data is not collected.

In an embodiment, the safety protection method further includes:

controlling the display connected with the controller such that the display displays the indicating information to indicate that the safe operating condition is not satisfied if the safe operating condition is not satisfied; and/or

controlling the alarm connected to the controller such that the alarm sends alarm information if the safe operating condition is not satisfied.

An embodiment of the present application further provides a safety protection device for engineering machinery, where the device is applied to the controller in any one of the above safety protection systems for the engineering machinery, the safety protection device includes: a detecting module, an obtaining module, a determining module and a control module;

the detecting module is configured for detecting whether the pilot electromagnetic valve is power on.

the obtaining module is configured for obtaining a plurality sets of operating data collected by the plurality sets of sensors if the pilot electromagnetic valve is power on.

the determining module is configured for determining whether the preset safe operating condition is satisfied according to the plurality sets of operating data.

the control module is configured for shutting off the control valve to prevent the hydraulic oil from supplying oil to the operating mechanism if the safe operating condition is not satisfied.

In an embodiment, the plurality sets of sensors include: a set of gravity sensors arranged below an operating seat, a set of distance sensors arranged at an inner side of a backrest of the operating seat, a set of pressure sensors arranged at an operating part of the operating mechanism;

the determining module is configured for:

determining whether the operator obeys a preset driving specification according to gravity data collected by the set of gravity sensors and distance data collected by the set of distance sensors;

determining whether the operator performs an operating action according to pressure data collected by the set of pressure sensors;

determining that the safe operating condition is not satisfied if the operator does not obey the driving specification, and/or the operator does not perform the operating action; and

determining that the safe operating condition is satisfied if the operator obeys the driving specification, and the operator performs the operating action.

In an embodiment, the determining module is configured for:

determining whether the gravity data are greater than or equal to a preset gravity threshold;

determining whether the distance data is within a preset safe distance range;

determining that the operator obeys the driving specification if the gravity data is greater than or equal to the preset gravity threshold and the distance data is within the preset safe distance range; and

determining that the operator does not obey the driving specification if the gravity data is less than the preset gravity threshold, and/or the distance data is not within the present safe distance range.

In an embodiment, the determining module is further configured for:

determining whether the pressure data are greater than or equal to a preset pressure threshold;

determining that the operator performs the operating action if the pressure data is greater than or equal to the preset the pressure threshold; and

determining that the operator does not perform the operating action if the pressure data are less than the preset pressure threshold.

In an embodiment, the determining module is further configured for:

determining whether the set of pressure sensors has collected the pressure data;

determining that the operator performs the operating action if the pressure data is collected; and

determining that the operator does not perform the operating action if pressure data is not collected.

In an embodiment, the control module is further configured for:

controlling the display connected with the controller such that the display displays the indicating information to indicate that the safe operating condition is not satisfied if the safe operating condition is not satisfied; and/or

controlling the alarm connected to the controller such that the alarm sends alarm information if the safe operating condition is not satisfied.

An embodiment of the present application further provides a controller, including a memory and a processor, where the memory stores a computer program that can be executed by the processor, and when executing the computer program, the processor implements the steps of any one the above safety protection methods for engineering machinery.

An embodiment of the present application further provides a computer readable storage medium on which a computer program is stored, where when the computer program is read and executed, implementing the steps of any one the above safety protection methods for engineering machinery.

An embodiment of the present application further provides an engineering machinery, including any one of the above safety protection systems for engineering machinery and at least one hydraulic actuator, where an oil inlet end of the oil passage of the safety protection system for engineering machinery is connected with an output end of the oil passage of at least one hydraulic actuator.

The beneficial effects of the present application are as follows.

The present application provides the safety protection system and the safety protection method for engineering machinery. The safety protection system includes a plurality sets of sensors, a controller, a control valve, a hydraulic safety valve and an operating mechanism. The control valve, the hydraulic safety valve and the operating mechanism are connected by an oil passage in sequence. The controller is electrically connected with a pilot electromagnetic valve in the hydraulic safety valve to detect whether the pilot electromagnetic valve is power on. The plurality sets of sensors are respectively arranged at different positions in an operating chamber of the engineering machinery. The controller is electrically connected with the plurality sets of sensors to detect a plurality sets of operating data obtained from the plurality sets of sensors when the pilot electromagnetic valve is power on. The controller is further electrically connected with the control valve to determine whether a safe operating condition is satisfied according to the plurality sets of operating data. If the safe operating condition is not satisfied, the control valve is shut off to prevent hydraulic oil from supplying oil to the operating mechanism. In the solutions of the present application, by respectively arranging the plurality sets of sensors at different positions in an operating chamber of the engineering machinery, and arranging a control valve in the oil passage of the engineering machinery, when the controller detects that the pilot electromagnetic valve is power on, the plurality sets of operating data are obtained from the plurality sets of sensors, and according to plurality sets of operating data, it is determined whether the safety operating condition is satisfied. If the safety operating condition is not satisfied, the control valve is shut off to prevent the hydraulic oil from supplying oil to the operating mechanism, which can detect an operating state of the driver in real time, and realize the safety protection of the engineering machinery in a working state, thus improving the safety of the engineering machinery.

In addition, the controller can process a plurality sets of data obtained from a plurality sets of sensors in real time, which has fast response speed and good real-time performance.

Secondly, the safety protection system for engineering machinery is improved based on the existing hydraulic safety lock without affecting the driver's existing operating habits.

Finally, the safety protection system further includes: a display and an alarm. The controller electrically connects the display and the alarm such that the display displays the corresponding indicating information on the display when determining that the safety operating condition is not satisfied, and such that the alarm sends the corresponding alarm information. By using the display and the alarm simultaneously to remind, this has enhanced human-machine interaction, reduced the probability of accidents, and achieved a purpose of improving the safety of engineering machinery.

### BRIEF DESCRIPTION OF THE DRAWINGS

In order to more clearly illustrate the solutions according to the present application or the prior art, the accompanying drawings used in the description of the embodiments or the prior art will be briefly introduced below. It should be noted that the drawings in the following description are a part of embodiments of the present application. For those of ordinary skill in the art, other drawings can also be obtained according to these drawings without creative efforts.

FIG. 1 is a structural diagram of a safety protection system for engineering machinery provided by an embodiment of the present application.

FIG. 2 is a structural diagram of another safety protection system for engineering machinery provided by an embodiment of the present application.

FIG. 3 is a structural diagram of a further safety protection system for engineering machinery provided by an embodiment of the present application.

FIG. 4 is a flow diagram of a safety protection method for engineering machinery provided by an embodiment of the present application.

FIG. 5 is a structural diagram of a safety protection device for engineering machinery provided by an embodiment of the present application.

FIG. 6 is a structural diagram of a controller provided by an embodiment of the present application.

### REFERENCE NUMERALS

100: safety protection system for engineering machinery; 101: plurality sets of sensors; 102: controller; 103: control valve; 104: hydraulic safety valve; 105: operating mechanism; 106: pilot electromagnetic valve; 107: hydraulic system; 108: first set of sensors; 109: second set of sensors; 110: third set of sensors; 201: display; 301: alarm; 601: processor; 602: memory.

### DETAILED DESCRIPTION

In order to more clearly illustrate the objectives, solutions, and advantages of the present application, the solutions of the present application will be clearly and completely described below in combination with the accompanying drawings of the present application. It should be noted that, the described embodiments are a part of embodiments of the present application, rather than all the embodiments.

The present application provides the following embodiments to realize a safety protection of engineering machinery. This realizes an automatic safety protection of engineering machinery under a working condition, and improve the safety of engineering machinery, which will be explained below by embodiments.

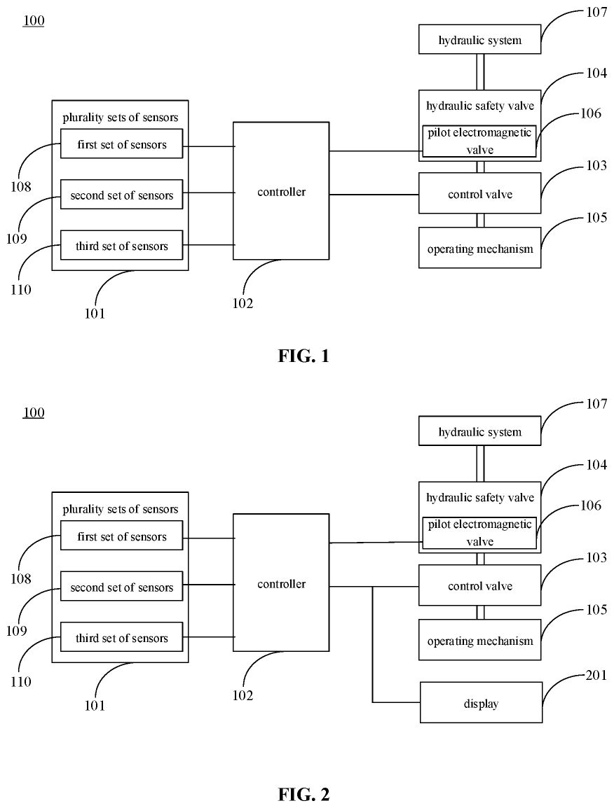

FIG. 1 is a structural diagram of a safety protection system for engineering machinery provided by an embodiment of the present application. As shown in FIG. 1, the safety protection system for engineering machinery 100 includes: a plurality sets of sensors 101, a controller 102, a control valve 103, a hydraulic safety valve 104 and an operating mechanism 105. The hydraulic safety valve 104 can also be called a pilot switch, which is provided with a pilot electromagnetic valve 106. The opening and closing of an oil passage of the hydraulic safety valve 104 are controlled by the pilot electromagnetic valve 106. When the pilot electromagnetic valve 106 is power on, hydraulic oil in an oil passage of a hydraulic system 107 can reach the operating mechanism 105, and the operating mechanism 105 can include an operating handle and a pedal valve. The hydraulic system 107 can respond to various operating actions performed by the operating mechanism 105 in real time. When the pilot electromagnetic valve 106 is not power on, the hydraulic oil in an oil passage of the hydraulic system 107 cannot reach the operating mechanism 105. The hydraulic system 107 does not respond to various operating actions performed by the operating mechanism 105.

Therefore, the hydraulic safety valve 104 can be used as a switch of the safety protection system for engineering machinery 100. When the pilot electromagnetic valve 106 in the hydraulic safety valve 104 is power on, the controller 102 can determine that the engineering machinery is in a working condition and the safety protection system for engineering machinery 100 is open. When the pilot electromagnetic valve 106 in the hydraulic safety valve 104 is not power on, the operating actions will not be responded. The controller 102 can determine that the engineering machinery is in a non-working state. The safety protection system for engineering machinery 100 is turned off.

The control valve 103, the hydraulic safety valve 104 and the operating mechanism 105 are connected by an oil passage in sequence. The controller 102 is electrically connected with a pilot electromagnetic valve 106 in the hydraulic safety valve 104 to detect whether the pilot electromagnetic valve 106 is power on. The plurality sets of sensors 101 are respectively arranged at different positions in an operating chamber of the engineering machinery. Data can be collected in real time from the plurality sets of sensors 101, and the arrangement of the plurality sets of sensors 101 can be flexibly adjusted. For example, the plurality sets of sensors 101 can be three sets or four sets according to actual needs. For example, there are three sets of sensors arranged in this embodiment respectively: a first set of sensors 108, a second set of sensors 109 and a third set of sensors 110. Different operating data of engineering machinery can be collected by three sets of sensors. No specific limitation is made here.

The controller 102 is electrically connected to the plurality sets of sensors 101 to detect a plurality sets of operating data obtained from the plurality sets of sensors 101 when the pilot electromagnetic valve 106 is power on. That is, when the controller 102 detects an electrical signal of the pilot electromagnetic valve 106 in the hydraulic safety valve 104, it can be determined that the engineering machinery is in a working state. The controller 102 obtains the plurality sets of operating data collected in real time by the plurality sets of sensors 101, and performs corresponding operations with respect to the received plurality sets of operations. If the controller 102 does not detect the electrical signal of the pilot electromagnetic valve 106 in the hydraulic safety valve 104, it can be determined that the engineering machinery is in a non-working state, and the safety protection system for engineering machinery 100 is turned off.

The controller 102 is further electrically connected to the control valve 103. By arranging the control valve 103 on the oil passage of the operating mechanism 105, the safety protection of the engineering machinery is achieved without affecting an operator's existing operating habits.

The controller 102 is used to determine whether the safe operating condition is satisfied according to the plurality sets of operating data. If the safe operating condition is not satisfied, the control valve 103 is shut off to prevent the hydraulic oil from supplying oil to the operating mechanism 105, so that corresponding operations of the operating mechanism 105 does not respond, which avoids an accident caused by non-standard operations of a driver or wrong touch of the operating mechanism 105 when the pilot electromagnetic valve 106 in the hydraulic safety valve 104 is power on, realizes a real-time safety protection of the engineering machinery when the engineering machinery is working normally, and improves the safety when using the engineering machinery.

In summary, the present application provides the safety protection system for engineering machinery. The safety protection system includes a plurality sets of sensors, a controller, a control valve, a hydraulic safety valve and an operating mechanism. The control valve, the hydraulic safety valve and the operating mechanism are connected by an oil passage in sequence. The controller is electrically connected with a pilot electromagnetic valve in the hydraulic safety valve to detect whether the pilot electromagnetic valve is power on. The plurality sets of sensors are respectively arranged at different positions in an operating chamber of the engineering machinery. The controller is electrically connected with the plurality sets of sensors to detect a plurality sets of operating data obtained from the plurality sets of sensors when the pilot electromagnetic valve is power on. The controller is further electrically connected with the control valve to determine whether a safe operating condition is satisfied according to the plurality sets of operating data. If the safe operating condition is not satisfied, the control valve is shut off to prevent hydraulic oil from supplying oil to the operating mechanism. In the solutions of the present application, by respectively arranging the plurality sets of sensors and a control valve in the safety protection system for engineering machinery, when the controller detects that the pilot electromagnetic valve is power on, the plurality sets of operating data are obtained from the plurality sets of sensors, and according to plurality sets of operating data, it is determined whether the safety operating conditions are satisfied. If the safety operating condition is not satisfied, the control valve is shut off to prevent the hydraulic oil from supplying oil to the operating mechanism, which realizes the safety protection of the engineering machinery in a working state, thus improving the safety of the engineering machinery.

In an embodiment, the plurality sets of sensors include: a set of gravity sensors, a set of distance sensors, and a set of pressure sensors. The set of gravity sensors is arranged below an operating seat to detect whether an operator is in a driving position. The set of distance sensors is arranged at an inner side of a backrest of the operating seat to detect a distance between a back of the operator and the backrest. The set of pressure sensors is arranged at an operating part of the operating mechanism to detect whether the operator performs an operating action.

In some embodiments, for example, the first set of sensors 108 can be a set of gravity sensors, and the set of gravity sensors can be arranged below an operating seat of an operating chamber of the engineering machinery to detect whether an operator is in a driving position to detect whether the operator is in the driving position. When the operator is in the driving position, the gravity sensors can detect gravity information, but when the operator leaves the driving position, the gravity sensors cannot detect the gravity information. Therefore, the gravity sensors can be used to detect whether the operator is in the driving position.

The second set of sensors 109 can be a set of distance sensors, the distance sensors are arranged at an inner side of the backrest of the operating seat to detect a distance between a back of the operator and the backrest. When the operator is in the driving position, accordingly, the back of the operator and the backrest there is a distance, for example, when the operator is in the driving position, the back of the operator does not cling to the backrest, the distance sensors detect that the distance is greater than zero, but when the back of the operator clings to the backrest, the distance sensors detect that the distance is equal to zero. It can be determined whether the operator's operating posture conforms to a driving specification according to data detected by the gravity sensors and the distance sensors.

The third set of sensors 110 can be a set of pressure sensors, which are arranged at an operating part of the operating mechanism to detect whether the operator performs an operating action. For example, the pressure sensors can be arranged on each operating mechanism, for example, set on an operating handle, a push rod and a pedal.

For example, when the operator performs a forward action, the operator performs a corresponding control action through an operating rod of the engineering machinery. A pressure signal or an electrical signal generated by this operating action of the operating rod can be detected by the pressure sensors connected to the operating rod, which has realized the detection of whether the operator performs the operating action by the pressure sensors.

Based on the safety protection system for engineering machinery shown above, the embodiment of the present application further provides a possible realization method of the safety protection system for engineering machinery, which is explained by an example as follows. FIG. 2 is a structural diagram of another safety protection system for engineering machinery provided by an embodiment of the present application. As shown in FIG. 2, the safety protection system for engineering machinery 100 further includes a display 201.

The controller 102 is further electrically connected to the display 201 such that the display displays corresponding indicating information on the display 201 when it is determined that the safe operating condition is not satisfied.

For example, when the controller 102 determines that the operator's operating posture does not conform to the driving specifications according to the data detected by the gravity sensors and the distance sensors, the display 201 can display a prompt information that the operator's operating posture does not conform to the driving specifications, which enables the operator to adjust the operating posture in time according to the prompt information, thereby improving the driving standardization, reducing the probability of accidents, and achieving the purpose of improving the safety of engineering machinery.

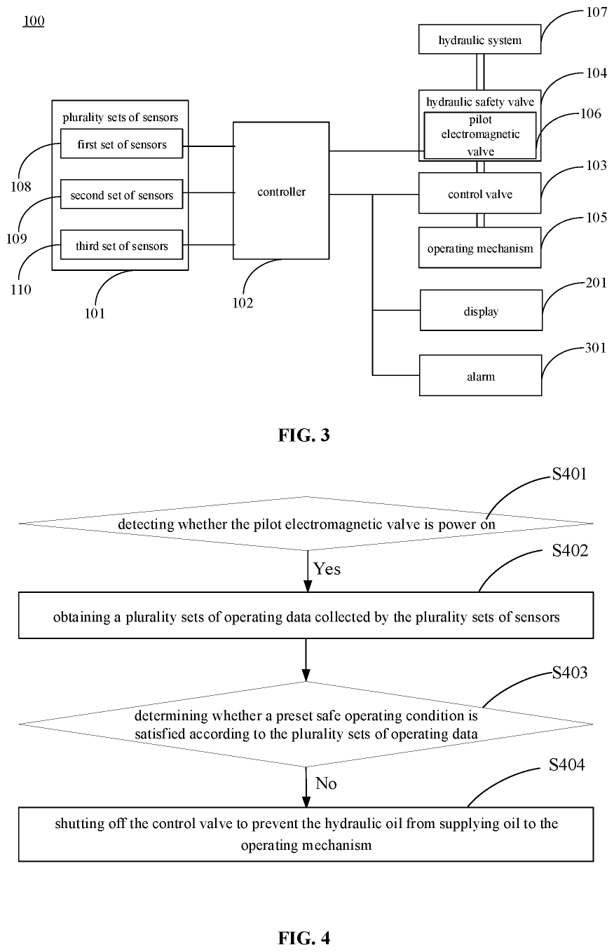

FIG. 3 is a structural diagram of a third safety protection system for engineering machinery provided by an embodiment of the present application. As shown in FIG. 3, based on the embodiments mentioned above, the safety protection system for engineering machinery 100 further includes alarm 301.

The controller 102 is further electrically connected to the alarm 301 such that the alarm 301 sends corresponding alarm information when it is determined that the safe operating condition is not satisfied.

For example, based on the embodiments mentioned above, the alarm information can also be sent through the alarm 301, which can give an alarm prompt in time for the operator's operating posture that does not conform to the driving specification. The alarm information can be that the alarm 301 alarms and flashes, or voice alarm information, which can visually enhance human-computer interaction, reduce the probability of dangerous accidents, thereby improving the safety of engineering machinery use.

It should be noted that when the controller 102 determines that the safe operating condition is satisfied, the alarm 301 returns to normal and no longer sends the corresponding alarm information.

The embodiments of the present application further provide a safety protection system for engineering machinery, including: a display and an alarm. The controller electrically connects the display and the alarm such that the display displays the corresponding indicating information on the display when determining that the safety operating condition is not satisfied, and such that the alarm sends the corresponding alarm information. By using the display and the alarm simultaneously to remind, this has enhanced human-machine interaction, reduced the probability of accidents, and achieved a purpose of improving the safety of engineering machinery. In addition, the safety protection system for engineering machinery is improved on the basis of an existing hydraulic safety lock, without affecting the driver's existing operating habits.

Based on the safety protection system for engineering machinery shown above, the embodiment of the present application further provides an implementation example of a control method applied to a controller in the safety protection system for engineering machinery, as described below. FIG. 4 is a flow diagram of a safety protection method for engineering machinery provided by an embodiment of the present application. The safety protection method can be applied to a controller in any one of the safety protection systems for engineering machinery mentioned above. The safety protection system includes the following steps.

S401: the pilot electromagnetic valve is detected whether is power on.

Usually, when the pilot electromagnetic valve in the hydraulic safety lock is power on, the controller can determine that the engineering machinery is in a working state, and a protection function in the safety protection systems for engineering machinery mentioned above is opened, so that the controller continues to perform the following S402-S403 operations. When the pilot electromagnetic valve in the hydraulic safety valve is not power on, the operation has no response. The controller can determine that the engineering machinery is in a non-working state, the protection function in the safety protection systems for engineering machinery mentioned above is shut down, and do not need to perform the following operations, so as to ensure the safety protection systems for engineering machinery in the working state and non-working state.

Therefore, the controller can detect whether the pilot electromagnetic valve is power on, and further determine whether the engineering machinery meets preset safe operating conditions in the working state, to avoid a false triggering of the engineering machinery in the working state and realize a false triggering protection.

S402: plurality sets of operating data collected by plurality sets of sensors are obtained if the pilot electromagnetic valve is power on.

For example, when the controller detects that the pilot electromagnetic valve is power on, it can be determined that the engineering machinery is currently in the working state and needs to be safely protected. Therefore, after the pilot electromagnetic valve being power on is detected, the controller obtains the plurality sets of operating data collected by the plurality sets of sensors in real time. For example, the plurality sets of operating data can include: gravity information of a driving position collected by the gravity sensors, distance data of a distance between a back of the operator and the backrest, etc. These will not be given a detailed description here, and the plurality sets of operating data obtained can be determined according to actual arrangement of plurality sets of sensors.

S403: whether the preset safe operating condition is satisfied is determined that according to the plurality sets of operating data.

Based on the embodiments mentioned above, after the controller acquires plurality sets of operating data collected by plurality sets of sensors, it is determined whether the plurality sets of operating data mentioned above meet the preset safe operating conditions, so that the controller can perform corresponding safety protection according to whether the plurality sets of operating data mentioned above meet the preset safe operating conditions.

S404: the control valve is shut off to prevent the hydraulic oil from supplying oil to the operating mechanism if the safe operating condition is not satisfied.

If it is determined that the preset safe operating condition is not satisfied according to the plurality sets of operating data, the controller shuts off the control valve to prevent the hydraulic oil from supplying oil to the operating mechanism. Thus, the corresponding operation has no response, so that the engineering machinery can be carried out in the working state. Safety protection can be carried out to improve the safety of the engineering machinery.

In an embodiment, if the preset safe operating condition is determined to be satisfied according to the plurality sets of operating data, the controller control valve is opened, and the hydraulic oil in the hydraulic system can supply oil to the operating mechanism. The corresponding operating actions of the operating mechanism can be responded in real time, which improves the safety of operating engineering machinery.

In some embodiments, for example, after obtaining the plurality sets of operating data collected by the plurality sets of sensors, and determining whether the preset safe operating condition is satisfied according to the plurality sets of sensors. For example, the preset safe operating conditions can include: gravity signal data detected by the gravity sensors needs to be greater than 400 N and distance signal data detected by the distance sensors needs to be within a safe distance range, etc., and the preset safe operating condition can be flexibly adjusted according to different working conditions.

For example, when the gravity signal data detected by the gravity sensors is 300 N, it can be determined that the gravity signal data does not meet the preset gravity signal data, that is, 300 N<400 N. The controller shuts off the control valve to prevent the hydraulic oil from supplying oil to the operating mechanism. The corresponding operation has no response, which effectively avoids an occurrence of unsafe accidents and improves the safety of engineering machinery.

For another example, when the gravity signal data detected by the gravity sensors is 500 N, but the distance signal data detected by the distance sensors is not within the safe distance range, it is determined that the current safety operating condition is still not satisfied, and the controller shuts off the control valve to prevent the hydraulic oil from supplying oil to the operating mechanism. The corresponding operation has no response, which achieves a purpose of improving the safety of engineering machinery.

It should be noted that if the plurality sets of operating data mentioned above satisfy the safe operating condition, the control valve is opened, and the hydraulic system can respond in real time according to various operating actions.

In summary, the present application provides the safety protection method for engineering machinery. The safety protection method includes the following steps. The pilot electromagnetic valve is detected whether is power on. If the pilot electromagnetic valve is power on, a plurality sets of operating data collected by a plurality sets of sensors are obtained. Whether the preset safe operating conditions is satisfied is determined according to the plurality sets of operating data. If the safe operating condition is not satisfied, the control valve is shut off to prevent the hydraulic oil from supplying oil to the operating mechanism. In solutions of the present application, the controller first detects whether the pilot electromagnetic valve is power on. If the pilot electromagnetic valve is power on, a plurality sets of operating data collected by the plurality sets of sensors are obtained, and whether the preset safe operating condition is satisfied is determined according to the plurality sets of operating data. If it is not satisfied, the control valve is shut off, so that the hydraulic oil can be prevented from supplying oil to the operating mechanism, which realizes the automatic safety protection of the construction machinery in the working state, thus improving the safety of the engineering machinery.

In an embodiment, the plurality sets of sensors include: a set of gravity sensors arranged below an operating seat, a set of distance sensors arranged at an inner side of a backrest of the operating seat, and a set of pressure sensors arranged at an operating part of the operating mechanism.

Determining whether preset safe operating condition is satisfied according to the plurality sets of operating data includes:

determining whether the operator obeys a preset driving specification according to gravity data collected by the set of gravity sensors and distance data collected by the set of distance sensors;

determining whether the operator performs an operating action according to pressure data collected by the set of pressure sensors;

determining that the safe operating condition is not satisfied if the operator does not obey the driving specification, and/or the operator does not perform the operating actions; and

determining that the safe operating condition is satisfied if the operator obeys the driving specification, and the operator performs the operating actions.

In some embodiments, the arrangement of a plurality sets of sensors can be arranged according to actual needs, for example, a set of gravity sensors can be arranged below an operating seat, a set of distance sensors can be arranged at an inner side of a backrest of the operating seat, and a set of pressure sensors can be arranged at an operating part of the operating mechanism. The operating mechanism can be an operating handle, a push rod and a pedal, and the operation of the engineering machinery by an operator can be detected in real time through the arrangement of plurality sets of sensors.

Based on the embodiments mentioned above, it is can be determined whether the operator obeys a preset driving specification according to the gravity data collected by the set of gravity sensors and distance data collected by the set of distance sensors. For example, when the gravity data collected by the gravity sensors does not satisfy the preset gravity data, but the distance data collected by the distance sensors satisfies the preset distance data, it can be determined that the operator does not obey the preset driving specifications. As long as the collected gravity data and distance data satisfy the corresponding preset data at the same time, it can be determined that the operator obeys the preset driving specifications.

For another example, it is can be determined whether the operator performs an operating action according to pressure data collected by the set of pressure sensors. It should be noted that when the operator is performing a forward action, the operator performs a corresponding control action through an operating rod of the engineering machinery. Thus, a pressure signal or an electrical signal generated by this operating action of the operating rod can be detected by the pressure sensors connected to the operating rod. The pressure sensors detect whether the operator performs the operating actions.

If it is determined that the operator does not obey the driving specifications, regardless of whether the operator performs the operating action, it can be determined that the safe operating condition is not currently satisfied.

If it is determined that the operator obeys the driving specifications and the operator performs the operating action, it can be determined that the safe operating condition is currently satisfied.

The determining whether the operator obeys a preset driving specification according to gravity data collected by the set of gravity sensors and distance data collected by the set of distance sensors includes:

determining whether the gravity data are greater than or equal to a preset gravity threshold;

determining whether the distance data is within a preset safe distance range;

determining that the operator obeys the driving specification if the gravity data is greater than or equal to the preset gravity threshold and the distance data is within the preset safe distance range; and

determining that the operator does not obey the driving specification if the gravity data is less than the preset gravity threshold, and/or the distance data is not within the present safe distance range, which can improve the standardization of operators driving construction machinery, reduce the probability of dangerous accidents, and improve the safety of construction machinery operation.

In an embodiment, the determining whether the operator performs an operating action according to pressure data collected by the set of pressure sensors includes:

determining whether the pressure data are greater than or equal to a preset pressure threshold;

determining that the operator performs the operating action if the pressure data is greater than or equal to the preset the pressure threshold; and

determining that the operator does not perform the operating action if the pressure data are less than the preset pressure threshold.

It should be noted that as long as the operator performs the operating action, a pressure signal or an electrical signal will be generated by the operating mechanism corresponding to the operating action can be detected by the pressure sensors whether the operator performs the action.

In some embodiments, for example, when the operator performs a backward action, the operator performs a corresponding control action through an operating rod of the engineering machinery. A pressure signal or an electrical signal generated by this operating action of the operating rod can be detected by the pressure sensors connected to the operating rod, and whether the pressure signal data is greater than or equal to the preset pressure threshold is determined. If the pressure data is greater than or equal to the preset pressure threshold, the operator is determined to perform the operating action. For example, the preset pressure threshold is 2, and there is no specific limit on the preset pressure threshold. When the obtained pressure data is 5. It can be determined that the pressure signal data is greater than the preset pressure threshold, that is, 5>2, that is, the operator can be determined to perform a backward operating action.

If the obtained pressure data is less than the preset pressure threshold, it is determined that the operator has not performed the operating action. In this way, it can be determined whether the pressure data collected by the pressure sensor is greater than the preset pressure threshold to determine whether the operator performs the operating action, which improves the real-time processing.

In an embodiment, the determining whether the operator performs an operating action according to pressure data collected by the set of pressure sensors includes:

determining whether the set of pressure sensors has collected the pressure data;

determining that the operator performs the operating action if the pressure data is collected; and

determining that the operator does performed the operating action if pressure data is not collected.

In other embodiments, according to whether the pressure sensor collects the pressure data to determine the operator to perform the operation action, for example, when the operator does not perform the backward action, accordingly, the operator does not operate the push rod to perform the corresponding control action, thus the pressure sensor connected with the push rod does not collect the pressure signal or electrical signal, it can be determined that the operator does not perform the operation action.

In an embodiment, the safety protection method for engineering machinery further includes: if the safe operating condition is not satisfied, the display connected to the controller is controlled to display a prompt information to indicate that the safe operating condition is not satisfied; and/or

if the safe operating condition is not satisfied, the alarm connected to the controller is controlled to send an alarm information.

For example, based on the embodiments mentioned above, when a plurality sets of operating data do not meet the operating conditions, for example, when determining the operator to perform the operating action according to the pressure data collected by the pressure sensors, a control command is sent to the display through the controller, so that the prompt information is displayed on the display, and the operator can stop the corresponding operating action in time according to the prompt information, avoiding the probability of a dangerous accident, and achieving the purpose of improving the safety of the use of engineering machinery.

In an embodiment, the alarm information can also be sent through the alarm, which can give an alarm prompt in time for the operator's operating posture that does not conform to the driving specification. The alarm information can be that the alarm 301 alarms and flashes, or voice alarm information, which can visually enhance human-computer interaction, reduce the probability of dangerous accidents, thereby improving the safety of engineering machinery use.

The following describes the device, controller, storage media and engineering machinery used to implement the safety protection method for the engineering machinery provided by the present application. The specific implementation process and effects have been described above, and will not be repeated below.

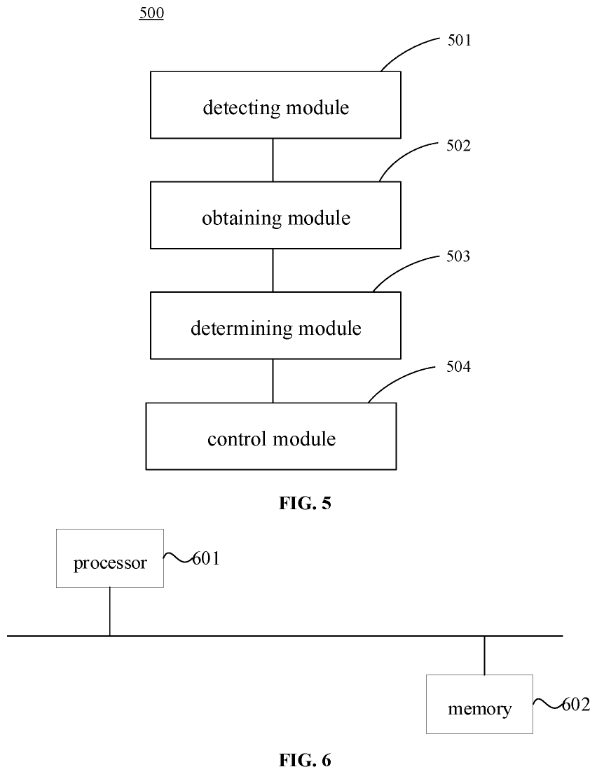

FIG. 5 is a structural diagram of a safety protection device for engineering machinery provided by an embodiment of the present application. As shown in FIG. 5, the safety protection device for engineering machinery 500 is applied to the controller in any one of the safety protection systems for the engineering machinery provided in any one of the above embodiments. The safety protection device includes: a detecting module 501, an obtaining module 502, a determining module 503 and a control module 504.

The detecting module 501 is configured for detecting whether the pilot electromagnetic valve is power on.

The obtaining module 502 is configured for obtaining a plurality sets of operating data collected by the plurality sets of sensors if the pilot electromagnetic valve is power on.

The determining module 503 is configured for determining whether the preset safe operating condition is satisfied according to the plurality sets of operating data.

The control module 504 is configured for shutting off the control valve to prevent the hydraulic oil from supplying oil to the operating mechanism if the safe operating condition is not satisfied.

In an embodiment, the plurality sets of sensors include: a set of gravity sensors arranged below an operating seat, a set of distance sensors arranged at an inner side of a backrest of the operating seat, a set of pressure sensors arranged at an operating part of the operating mechanism.

The determining module 503 is configured for: determining whether the operator obeys a preset driving specification according to gravity data collected by the set of gravity sensors and distance data collected by the set of distance sensors;

determining whether the operator performs an operating action according to pressure data collected by the set of pressure sensors;

determining that the safe operating condition is not satisfied if the operator does not obey the driving specification, and/or the operator does not perform the operating actions; and

determining that the safe operating condition is satisfied if the operator obeys the driving specification, and the operator performs the operating actions.

In an embodiment, the determining module 503 is configured for: determining whether the gravity data are greater than or equal to a preset gravity threshold;

determining whether the distance data is within a preset safe distance range;

determining that the operator obeys the driving specification if the gravity data is greater than or equal to the preset gravity threshold and the distance data is within the preset safe distance range; and

determining that the operator does not obey the driving specification if the gravity data is less than the preset gravity threshold, and/or the distance data is not within the present safe distance range.

In an embodiment, the determining module 503 is further configured for: determining whether the pressure data are greater than or equal to a preset pressure threshold;

determining that the operator performs the operating action if the pressure data is greater than or equal to the preset the pressure threshold; and

determining that the operator does not perform the operating action if the pressure data are less than the preset pressure threshold.

In an embodiment, the determining module 503 is further configured for: determining whether the set of pressure sensors has collected the pressure data;

determining that the operator performs the operating action if the pressure data is collected; and

determining that the operator does not perform the operating action if pressure data is not collected.

In an embodiment, the control module 504 is further configured for:

controlling the display connected with the controller such that the display displays the indicating information to indicate that the safe operating condition is not satisfied if the safe operating condition is not satisfied; and/or controlling the alarm connected to the controller such that the alarm sends alarm information if the safe operating condition is not satisfied.

The device mentioned above is used to implement the method provided in the aforementioned embodiment, and its implementation principle and effect are similar, do not be repeated here.

The modules mentioned above can be configured as one or more integrated circuits to implement the method mentioned above. Such as: one or more application specific integrated circuits (ASIC), or, one or more digital signal processor (DSP), or, one or more field programmable gate array (FPGA), etc. For another example, when the modules mentioned above are implemented in the form of component scheduling program code, the processing component can be a general-purpose processor, such as a central processing unit (CPU) or other processors that can call program code. These modules can be integrated together in the form of a system-on-a-chip (SOC).

FIG. 6 is a structural diagram of a controller provided by an embodiment of the present application. As shown in FIG. 6, the controller can be integrated into a control device or a chip of the control device, which can be the controller in the safety protection for the engineering machinery mentioned above.

The controller includes a memory 601 and a processor 602.

The memory 602 stores a computer program that can be executed by the processor 602, and when executing the computer program, the processor 602 implements the steps of any one the safety protection methods for engineering machinery provided by the embodiments mentioned above, to implement the method embodiments mentioned above. The specific implementation and effects are similar, and will not be repeated here.

In an embodiment, the present application further provides a program product, such as a computer readable storage medium, including a program that is used to perform the above method embodiment when executed by the processor.

In an embodiment, embodiments of the present application further provide an engineering machinery, including any one of the above safety protection systems for engineering machinery and at least one hydraulic actuator. Where, an oil inlet end of the oil passage of the safety protection system for engineering machinery is connected with an output end of the oil passage of at least one hydraulic actuator.

In several embodiments provided in the present application, it should be noted that the disclosed devices and methods can be realized in other ways. For example, the device embodiment described above is only schematic. For example, the division of the unit is only a logical function division, and the actual implementation can be divided in another way, such as a plurality of units or components can be combined or can be integrated into another system, or some features can be ignored or not executed. In addition, the coupling or direct coupling or communication connection between each other shown or discussed can be an indirect coupling or communication connection through some interface, device or unit, which can be electrical, mechanical or other form.

The units described as separation components can or cannot be physically separated, and the components shown as units can or cannot be physical units, i.e. can be located in one place or can be distributed over a plurality of network units. Some or all of these units can be selected according to actual needs to achieve the purpose of this embodiment purpose.

In addition, the functional units in each embodiment of the present application can be integrated into one processing unit, or each unit can exist physically alone, or two or more units can be integrated into one unit. The above integrated units can be implemented in the form of hardware or hardware plus software functional units.

The above integrated units in the form of software function units can be stored in a computer readable storage medium. The above software functional units are stored in a storage medium, including a number of instructions to enable a computer device (can be a personal computer, server, or network device, etc.) or processor to perform some of the steps described in each embodiment of this application. The aforementioned storage media includes: U disk, mobile hard disk, read-only memory (Read-Only Memory, referred to as: ROM), random access memory (Random Access Memory, referred to as: RAM), disk or disc and other media that can store program code.

1. A safety protection system for engineering machinery, comprising: a plurality sets of sensors, a controller, a control valve, a hydraulic safety valve and an operating mechanism, wherein the control valve, the hydraulic safety valve and the operating mechanism are connected by an oil passage in sequence,
wherein the controller is electrically connected with a pilot electromagnetic valve in the hydraulic safety valve to detect whether the pilot electromagnetic valve is power on,
wherein the plurality sets of sensors are arranged at different positions in an operating chamber of the engineering machinery respectively, and the controller is electrically connected with the plurality sets of sensors to detect a plurality sets of operating data obtained from the plurality sets of sensors in response to the pilot electromagnetic valve being power on, and
wherein the controller is further electrically connected with the control valve to determine whether a safe operating condition is satisfied according to the plurality sets of operating data, and to shut off the controller control valve to prevent hydraulic oil from supplying oil to the operating mechanism in response to the safe operating condition being not satisfied.

2. The safety protection system according to claim 1, wherein the plurality sets of sensors comprise: a set of gravity sensors, a set of distance sensors, and a set of pressure sensors, wherein the set of gravity sensors is arranged below an operating seat to detect whether an operator is in a driving position,
wherein the set of distance sensors is arranged at an inner side of a backrest of the operating seat to detect a distance between a back of the operator and the backrest, and
wherein the set of pressure sensors is arranged at an operating part of the operating mechanism to detect whether the operator performs an operating action.

3. The safety protection system according to claim 1, wherein the safety protection system further comprises: a display, wherein the controller is further electrically connected to the display such that the display displays corresponding indicating information on the display in response to determining that the safe operating condition is not satisfied.

4. The safety protection system according to claim 1, wherein the safety protection system further comprises: an alarm, wherein the controller is further electrically connected to the alarm such that the alarm sends corresponding alarm information in response to determining that the safe operating condition is not satisfied.

5. A safety protection method for engineering machinery, wherein the safety protection method is applied to the controller in safety protection system according to claim 1, and the safety protection method comprises:
detecting whether the pilot electromagnetic valve is power on;
obtaining a plurality sets of operating data collected by the plurality sets of sensors in response to the pilot electromagnetic valve being power on;
determining whether a preset safe operating condition is satisfied according to the plurality sets of operating data; and
shutting off the control valve to prevent the hydraulic oil from supplying oil to the operating mechanism in response the safe operating condition being not satisfied.

6. The safety protection method according to claim 5, wherein the plurality sets of sensors comprise: a set of gravity sensors arranged below an operating seat, a set of distance sensors arranged at an inner side of a backrest of the operating seat, and a set of pressure sensors arranged at an operating part of the operating mechanism,
wherein the determining whether the preset safe operating condition is satisfied according to the plurality sets of operating data comprises:
determining whether the operator obeys a preset driving specification according to gravity data collected by the set of gravity sensors and distance data collected by the set of distance sensors;
determining whether the operator performs an operating action according to pressure data collected by the set of pressure sensors;
determining that the safe operating condition is not satisfied, in response to determining that the operator does not obey the driving specification and/or the operator does not perform the operating action; and
determining that the safe operating condition is satisfied, in response to determining that the operator obeys the driving specification, and the operator performs the operating action.

7. The safety protection method according to claim 6, wherein the determining whether the operator obeys the preset driving specification according to gravity data collected by the set of gravity sensors and distance data collected by the set of distance sensors comprises:
determining whether the gravity data is greater than or equal to a preset gravity threshold;
determining whether the distance data is within a preset safe distance range;
determining that the operator obeys the driving specification in response to the gravity data being greater than or equal to the preset gravity threshold and the distance data being within the preset safe distance range; and
determining that the operator does not obey the driving specification in response to the gravity data being less than the preset gravity threshold and/or the distance data being not within the present safe distance range.

8. The safety protection method according to claim 6, wherein the determining whether the operator performs the operating action according to pressure data collected by the set of pressure sensors comprises:
determining whether the pressure data is greater than or equal to a preset pressure threshold;
determining that the operator performs the operating action in response to the pressure data being greater than or equal to the preset pressure threshold; and
determining that the operator does not perform the operating action in response to the pressure data being less than the preset pressure threshold.

9. The safety protection method according to claim 6, wherein the determining whether the operator performs the operating action according to pressure data collected by the set of pressure sensors comprises:
determining whether the pressure data is collected by the set of pressure sensors;
determining that the operator performs the operating action in response to the pressure data being collected; and
determining that the operator has not performed the operating action in response to pressure data being not collected.

10. The safety protection method according to claim 5, wherein the safety protection method further comprises:
controlling the display connected with the controller such that the display displays the indicating information to indicate that the safe operating condition is not satisfied in response to the safe operating condition being not satisfied; and/or
controlling the alarm connected to the controller such that the alarm sends alarm information in response to the safe operating condition being not satisfied.

11. The safety protection system according to claim 2, wherein the safety protection system further comprises: a display, wherein the controller is further electrically connected to the display such that the display displays corresponding indicating information on the display in response to determining that the safe operating condition is not satisfied.

12. The safety protection system according to claim 2, wherein the safety protection system further comprises: an alarm, wherein the controller is further electrically connected to the alarm such that the alarm sends corresponding alarm information in response to determining that the safe operating condition is not satisfied.

13. The safety protection method according to claim 6, wherein the safety protection method further comprises:
